(19) United States
(12) Patent Application Publication
(10) Pub. No.: US 2025/0251915 A1
(43) Pub. Date: Aug. 7, 2025

(54) System and methods for Generating Objects in Low-Code or No-Code Software Process Execution Environments

(71) Applicant: Appian Corporation, McLean, VA (US)

(72) Inventors: Rachel Frances Rater, Herndon, VA (US); George Ivan, Herndon, VA (US); Patrick Elliott Lynch, Mountlake Terrace, WA (US); Tadesse Getahun, Sterling, VA (US); Justin Charles Ingram, Herndon, VA (US); John Frederick Lentz, Sterling, VA (US); Yuehui Wang, San Francisco, CA (US)

(73) Assignee: Appian Corporation, McLean, VA (US)

(21) Appl. No.: 18/435,137

(22) Filed: Feb. 7, 2024

(51) Int. Cl. G06F 8/34

(52) U.S. Cl. CPC G06F 8/34

(57) ABSTRACT

Disclosed are methods, systems and non-transitory computer readable memory for generating objects in low-code or no-code software process execution environments. For instance, a method may include: receive a request to initiate an object templating subroutine; obtain a seed file, the seed file containing seed data relating to an object to be generated; and transmit the seed file to a user environment. The user environment may be configured to: perform validation and/or update actions to the seed data; and transmit the validated and/or updated seed data with a request to initiate an object generation subroutine. The method may further include, in response to receiving the validated and/or updated seed data and the request to initiate the object generation subroutine, generate the object by performing one or both of: (i) generating a new object; and (ii) modifying an existing object.

### TECHNICAL FIELD

Various aspects of the present disclosure relate generally to systems and methods for generating objects and, more particularly, to systems and methods for generating objects in low-code or no-code software process execution environments.

### BACKGROUND

Generally, software process execution environments require specialized knowledge on how to develop software processes, which sub-components of software processes are necessary at the outset of the development process, dependencies between sub-components of software processes, and how sub-components of software processes interact. Moreover, as application requirements evolve or change, no-code and low-code users may have to recall how references to changed, new, or deleted objects are made, in order to reflect any changes across the entire software process. However, no-code or low-code users may not consider or have access to some or all of these aspects while developing software processes. In order to leverage best practices, provide faster initial development, increase ease of modifications to existing software code, lower or eliminate the risk of bugs from certain types of code modifications, adopt enhancements identified by artificial intelligence or data analytics, increase system automation, and maintain system data security, there is a need for low code or no-code software process development in software process execution environments.

The present disclosure is directed to overcoming one or more of these above-referenced challenges.

### SUMMARY OF THE DISCLOSURE

According to certain aspects of the disclosure, systems, methods, and computer readable memory are disclosed for generating objects in low-code or no-code software process execution environments.

In some cases, a system for partially-automated software development may include: a processing unit comprising one or more processors; and one or more data stores comprising machine-readable instructions. The system may be configured to: receive a request to initiate an object templating subroutine; in response to the request to initiate the object templating subroutine, obtain a seed file, the seed file containing seed data relating to an object to be generated; perform validation and/or update actions to the seed data; and generate the object by performing an action.

In some cases, a computer-implemented method for partially-automated software development may include: receiving a request to initiate an object templating subroutine; in response to the request to initiate the object templating subroutine, obtaining a seed file, the seed file containing seed data relating to an object to be generated; performing validation and/or update actions to the seed data; and generating the object by performing one or both of: (i) generating a new object; and (ii) modifying an existing object.

In some cases, a system for partially-automated software development may include: a client device associated with a user account and configured to receive user intentions via graphical user interfaces; a frontend system configured to manage interactions with one or more client devices, the one or more client devices being configured to receive user intentions via one or more graphical user interfaces; and a backend system configured to manage a plurality of template recipes and generate software objects based on one or more of the plurality of template recipes. The system may be configured to: provide, via the frontend system, the graphical user interfaces to the client device; receive, via the frontend system, the user intentions from the client device; obtain, via the backend system, a seed file based on the user intentions, wherein the seed file contains seed data relating to an object to be generated; using the frontend system, perform validation and/or update actions to the seed data based on (1) design rules and (2) user requests, via the graphical user interfaces; in response to an instantiation condition being satisfied, generate, via the backend system and based on the validated and/or updated seed data, a second file configured to instantiate a run-time version of the object; and deploy the run-time version of the object.

In some cases, a computer-implemented method for partially-automated software development may include: providing, via a frontend system, graphical user interfaces to a client device; receiving, via the frontend system, user intentions from the client device; obtaining, via a backend system, a seed file based on the user intentions, wherein the seed file contains seed data relating to an object to be generated; using the frontend system, performing validation and/or update actions to the seed data based on (1) design rules and (2) user requests, via the graphical user interfaces; in response to an instantiation condition being satisfied, generating, via the backend system and based on the validated and/or updated seed data, a second file configured to instantiate a run-time version of the object; and deploying the run-time version of the object.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts an example environment for generating objects in a low-code or no-code software process execution environment.

FIG. 2 depicts a diagram schematically showing an object-based model comprising a plurality of process nodes of a low-code or no-code software process execution environment.

FIG. 3 depicts a block diagram schematically showing a backend generating objects in a low-code or no-code software process execution environment.

FIGS. 4A and 4B depict dataflow diagrams for generating objects in a low-code or no-code software process execution environment.

FIGS. 5A, 5B, 5C, 5D, 5E, 5F, 5G depict graphical user interfaces in a process to generate objects in a low-code or no-code software process execution environment.

FIG. 6 depicts an example system that may execute techniques presented herein.

### DETAILED DESCRIPTION

In general, the present disclosure is directed to methods and systems for generating and maintaining objects to be included in an application that is executed in a software process execution environment. In some cases, the software process execution environment is a low-code or no-code software process execution environment. As discussed in detail herein, systems of the present disclosure may include a backend 140 that may receive a request to initiate an object creation subroutine to generate one or more objects, to be used in an application, based on one or more template objects and metadata associated with a user or user account. Groups of template definitions, called recipes, may be used to generate multiple objects simultaneously. Individual recipes can be associated with particular aspects of an application, such that any time that particular aspect of an application is recreated, a same or similar set of objects are created from templates. Such a set of objects may be similar by virtue of being populated by different data and/or by virtue of only having a subset of objects in a particular receipt be created, based on inputs from a user.

In some cases, the object creation subroutine may automatically generate objects and optionally populate them with user-defined data (e.g., data provided by the user) or user-associated data (e.g., data hosted on the environment 103 and populated in an object for the user).

In some cases, an object template framework, which may exist within or be separate from the system, may obtain a seed file that contains seed data relating to an object to be generated. The object template framework may receive a request to generate a certain set of objects, which correspond to a recipe, the definitions of which exist in templates within the object template framework.

The object template framework creates seed files that contain seed data comprised of key-value pairs. Seed data can include predefined information based on user and system context, or information specified by a user initiating a request to generate the set of objects. The seed data can represent all data necessary to generate a particular object. In some cases, the seed files can have a non-binary, textual data format.

In some cases, the system may transmit the seed file to a user environment. The user environment may be configured to: perform validation and/or update actions to the seed data; and after validating and/or updating the seed data, transmit the validated and/or updated seed data with a request to initiate an object generation subroutine. In some cases, the validation and update actions may automatically check for certain conditions, as discussed herein, and (in some cases) allow the user to modify or change portions of the seed file.

In some cases, the system may receive the validated and/or updated seed data and generate an object. For instance the system may generate the object by performing one or both of: (i) generating a new object; and (ii) modifying an existing object.

Thus, in this manner, seed data of different template objects (alternatively referred to as template recipes) may be populated using user-provided or system-provided data in a process that ensures: (1) design consistency, (2) easier to update objects, (3) increased maintainability, (4) increased security, and (5) improved functional interoperability with the environment 103. Moreover, the process ensures that developers do not have to implement any particular design practices, structure, data population, security, or interoperability with the environment 103. Moreover, the system may leverage existing objects to generate complex software processes without generating all new objects or incomplete sets of objects.

Thus, methods and systems of the present disclosure may be improvements to computer technology and/or software process development.

### Environment

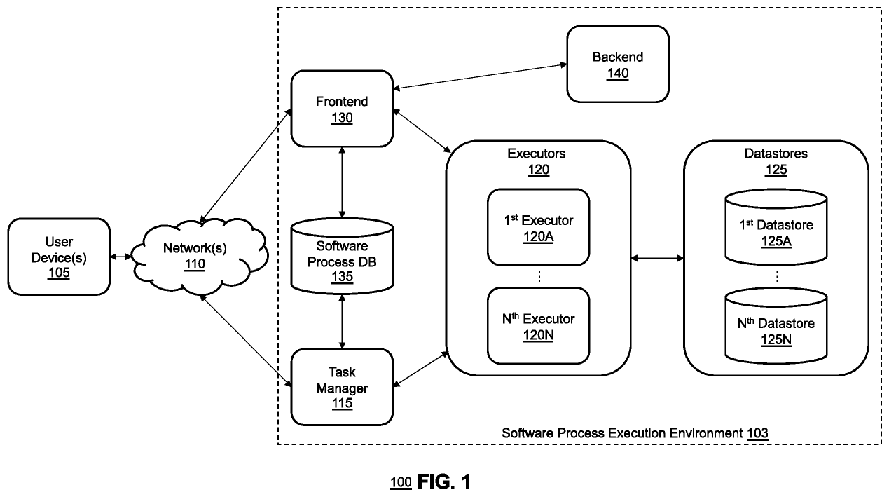

FIG. 1 shows an example environment 100 for generating objects in a software process execution environment 103. The environment 100 may include user device(s) 105, network(s) 110, and the software process execution environment 103. In some cases, the software process execution environment 103 may include a task manager 115, executors 120, datastores 125, a frontend 130, a software process database 135, and a backend 140. Generally, the software process execution environment 103 may interact with users to generate user-defined software processes and execute the user-defined software processes in the software process execution environment 103. In some cases the user-defined software processes may be executed in user or third-party hosted environments. In some cases, the software process execution environment 103 may have a compute layer, a storage layer, and a task manager, each of which can scale independently. In some cases, the compute layer's scale is bounded by the task manager scale. Software processes, including starting a software process, may be abstracted as tasks that executors to advance software processes. For instance, an executor may: pull a next task (e.g., query and receive) from a sub-group (e.g., from the task manager 115); retrieve a portion of code corresponding to the next task (e.g., from the software process database 135); execute the portion of code (e.g., retrieve data for one or more variables from local cache or a datastore 125, perform computations or inferences on retrieved data) to generate an updated variable or new variable; store, record, or output the updated variable or new variable (e.g., in cache or datastore 125, or to a separate system). The storage layer may persist in the process state, both external (e.g., variables of a software process) and internal (e.g., variables within the software process execution environment 103).

The user device(s) 105 (hereinafter “user device 105” for ease of reference) may be a personal computing device, such as a cell phone, a tablet, a laptop, or a desktop computer. In some cases, the user device 105 may be an extended reality (XR) device, such as a virtual reality device, an augmented reality device, a mixed reality device, and the like. In some cases, the user device 105 may be associated with a user (e.g., a user of or an end user of an organization of the software process execution environment 103) of services provided by the software process execution environment 103. For instance, in some cases, users (e.g., employees) or software functions of an organization may use (e.g., invoke) software processes to perform associated functions and actions. In some cases, users (e.g., end users of the organization), or software functions of end users (in the case the end user is also an organization) may use (e.g., invoke) software processes to perform associated functions or actions. The user may have a user account associated with the user device 105 that uniquely identifies the user (e.g., within the organization and the organization may have an organization account, or within the software process execution environment 103). In some cases, the user device 105 may be a server or computer system (e.g., a cloud service) associated with the organization.

The network(s) 110 may include one or more local networks, private networks, enterprise networks, public networks (such as the internet), cellular networks, and satellite networks, to connect the various devices in the environment 100. Generally, the various devices of the environment 100 may communicate over network(s) 110 using, e.g., network communication standards that connect endpoints corresponding to the various devices of the environment 100.

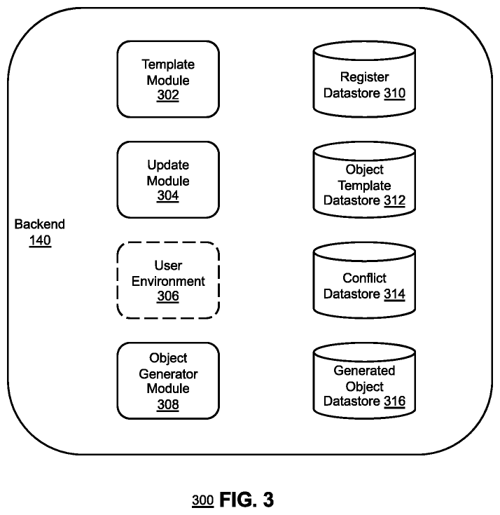

The frontend 130 may be a personal computing device, a server, a system of servers, a set of compute instances in the cloud (e.g., hosted by a cloud service provider), and the like. In some cases, the frontend 130 may interact with user devices to receive user inputs regarding software processes; and add, update, or delete software processes based on the user inputs regarding software processes, as discussed herein. See FIG. 3. For instance, the frontend 130 may manage user interactions and pass the user interactions to the backend 140, which hosts a software process development environment to enable users of user devices 105 to define, configure, and/or update software processes. In some cases, the software process development environment may enable the users to define software processes using a no-code or low code process.

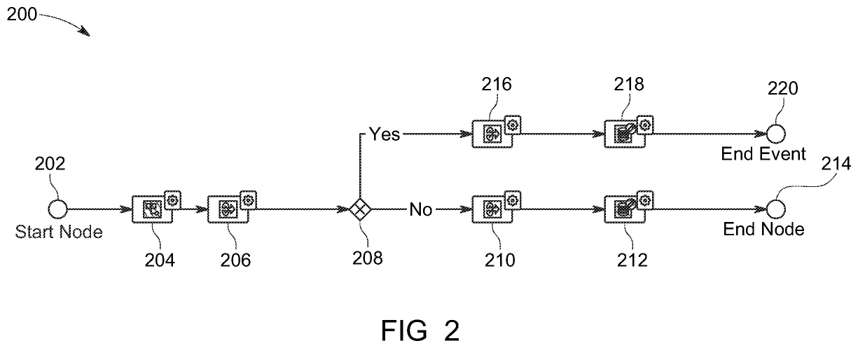

Generally, the software processes, each individually, may be configured to be represented in an object-based model. In some cases, the object-based model may be a graphical model. See, e.g., FIG. 2. An object-based model for a software process may include at least one process node, a set of process nodes (e.g., any of 1 to N nodes), and/or or a plurality of process nodes. The plurality of process nodes may include at least a first process node and a second process node. Each of the process nodes of the plurality of process nodes may correspond to a software subroutine. A software subroutine may include a discrete portion (or portions) of software executable code that advance a software process. In some cases, at least a first set of the plurality of process nodes, in accordance with software subroutines, may retrieve and perform operations on values of variables associated with the software process.

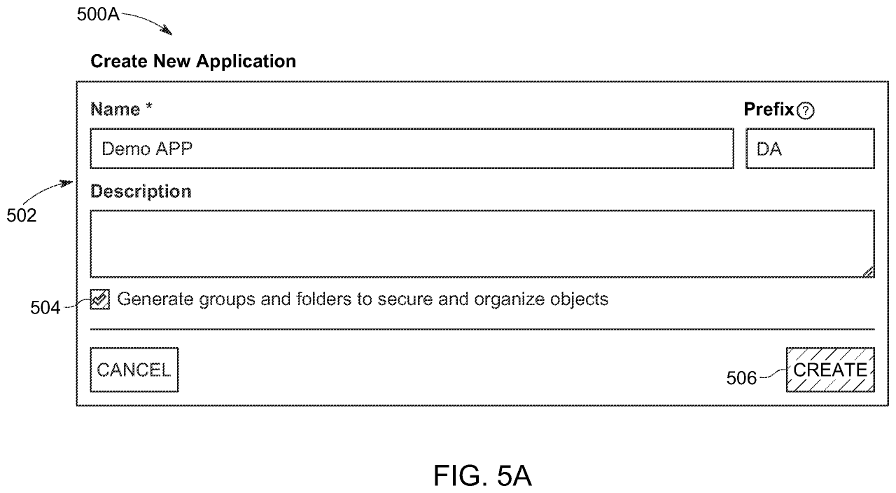

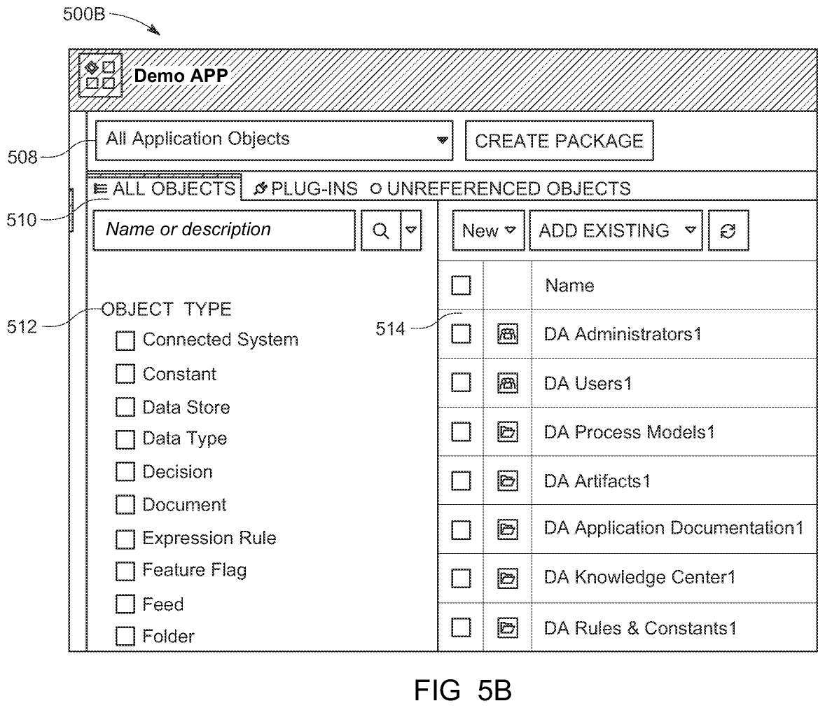

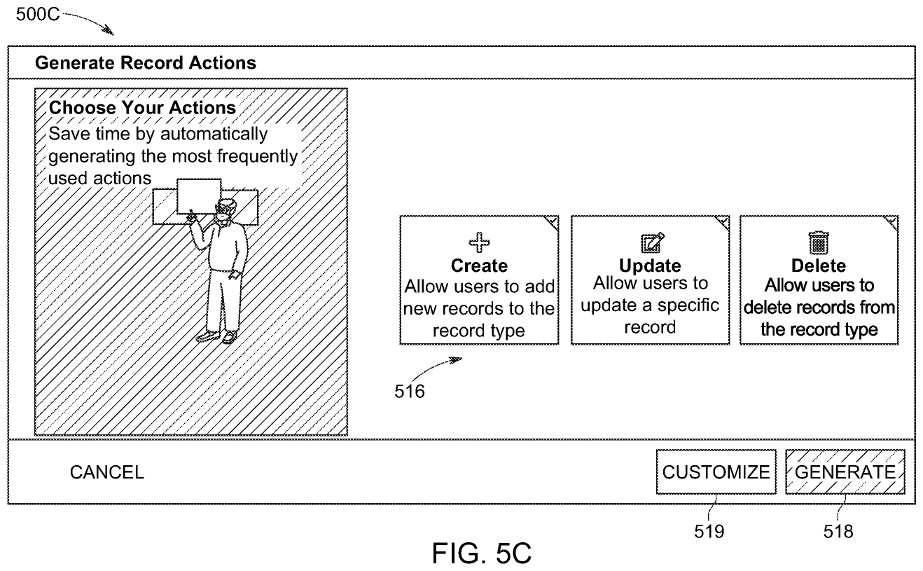

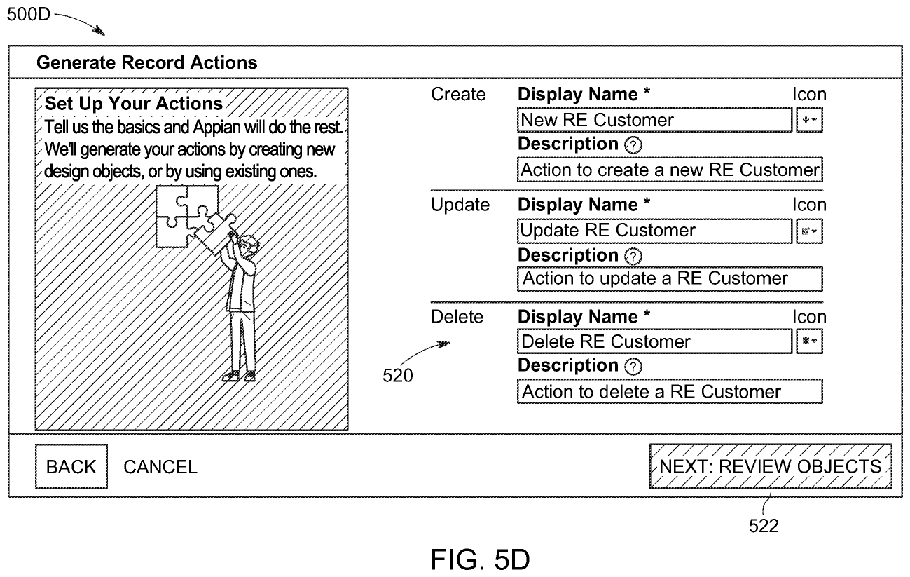

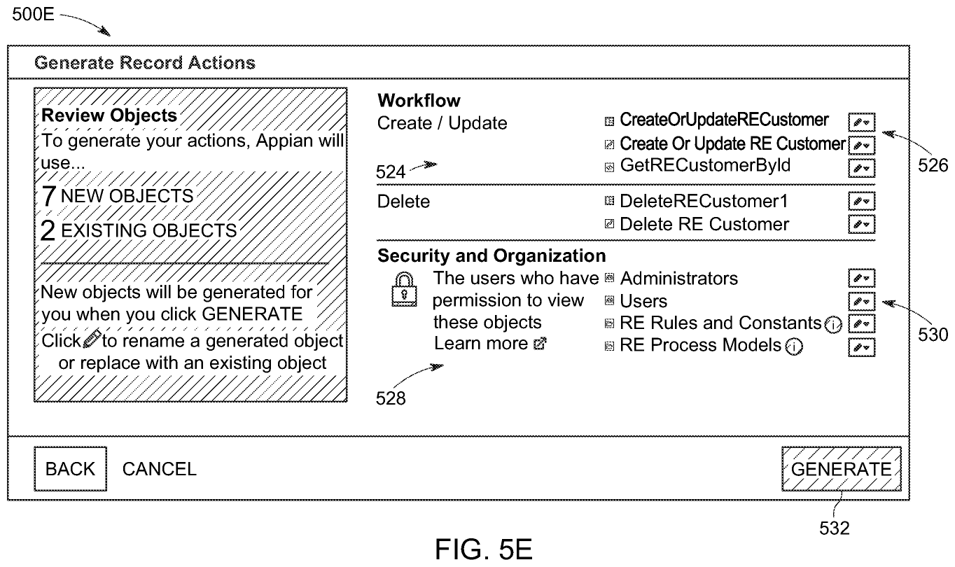

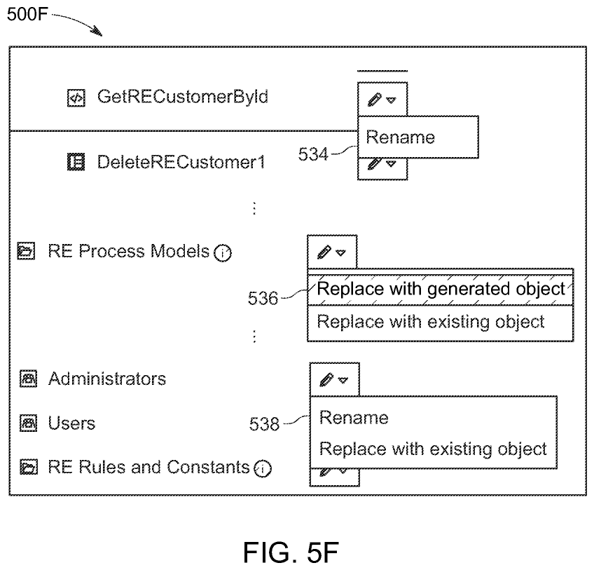

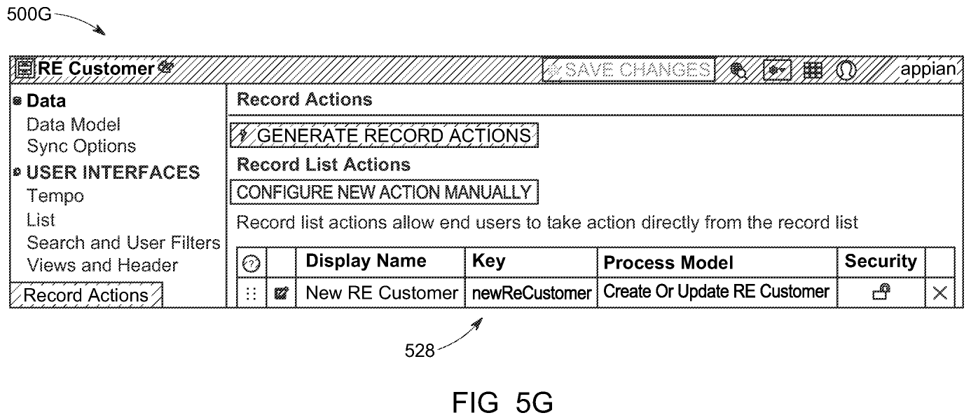

The backend 140 may host a software process development environment to add, update, or delete software processes based on the user inputs regarding software processes. For instance, the software process development environment may provide graphical user interfaces (see, e.g., FIGS. 5A-5G) for users to interact with the software process development environment to select, modify, and generate user-defined software processes. In some cases, the backend 140 may receive a first request from a user device and obtain a seed file, check the seed file, and generate an object based on seed data of the seed file, as discussed herein. In some cases, the backend 140 may interact with the user via graphical user interfaces to modify aspects of the seed data/features of the object, and then generate the object based on the modified seed data. After the object is generated, the backend 140 may store/transmit the object to various endpoints. In some cases, the object may be transmitted to a user device 105, to allow the object to run locally for the user. In some cases, the object may be transmitted to the software process database 135, so that the object may be stored for future execution in the software process execution environment 103. In some cases, these actions may be referred to as “deploying” the object for run time use. In some cases, the object may be stored in the generated object datastore 316 (see FIG. 3) to facilitate reuse of generated objects, e.g., by account, user, and the like.

In some cases, the frontend 130 may initiate specific software processes in response to triggering conditions associated with the specific software processes. In some cases, the triggering conditions may be defined by designer of the model (e.g., the end-user performing some action through a user interface, such as inputting data or submitting a form, or upon exceeding some threshold time after the end of a previous event) or determined or suggested by the software process execution environment 103. In some cases, the triggering conditions may be (1) time-based, and/or (2) event-based. A time-based trigger condition may initiate the specific software process at a set interval (e.g., each day, hour, and the like). An event-based trigger condition may initiate the specific software process in response to (1) a request from a user device 105 (e.g., a server of the organization), (2) a request from a different software process, (3) a request from a third-party server (e.g., a different service associated with the organization), and/or (4) a detection of a change in data stored in the datastores 125.

The software process database 135 may be a structured or unstructured database or other data storage system (e.g., time series database, a data lake, etc.). The software process database 135 may store software processes for users/organizations. The software process database 135 may provide (all or subroutines of) software processes to the executors 120, so that the executors 120 may execute tasks associated with nodes of the software processes. In response to instructions from the frontend 130, the software process database 135 may add software processes, update software processes (e.g., modify subroutines, arrangement of process nodes, etc.), or delete software processes or process nodes. The software process database 135 may store and manage the software processes in association with user or organization identifiers. The software process database 135 may restrict access to specific users (or groups of users) and/or specific organizations.

The executors 120 may be zero, one, or a plurality of executors. The executors 120 may be a compute layer for the software process execution environment 103. The executors 120 may be configured to execute tasks associated with software processes. The tasks may be entire subroutines or parts of subroutines (e.g., loop instances, recursive instances, or parallel parts of a subroutine associated with a process node). The executors 120 may be elastic and stateless. An executor of the executors 120 may be a single-tenant compute instance (i.e., association with a single user or organization). In some cases, the executors 120 may be a set of virtual machines (VMs). For instance, the VMs may be java virtual machines (JVMs). In some cases, the executors 120 may consume work requests from a work requests queue (e.g., managed by the task manager 115). In some cases, the executors 120 may be expression-evaluation environments that load (in-memory) types, usernames, rules, functions, smart services (a process node with a specific functionality and whose attributes can be specified by the designer), etc. referenced by the tasks the executors 120 consume.

In some cases, the executors 120 may, based on executor load (e.g., software process load, metrics of individual executors, metrics of software processes, etc.) and other factors, add or remove executors from the software process execution environment 103. Thus, the executors 120 may include zero, one, or a plurality of executors, as the load on the software process execution environment 103 increases or decreases. As depicted in FIG. 1, the executors 120 may include a first executor 120A through a Nth executor 120N, where the number of executors, N, is determined based on the load. As the load increases, new executors may be added to distribute process load across all executors of the executors 120. In some cases, new executors may receive tasks from existing executors. As the load decreases, existing executors may migrate tasks to remaining executors and end decommissioned executors. In some cases, migrated tasks may be moved between VMs on the same compute instance (e.g., server), or between VMs on different compute instances (e.g., servers).

For a specific initiation of a software process on the software process execution environment 103, the software process execution environment 103 may determine a subset (e.g., all or less than all) of executors 120 to execute tasks associated with one or more of the plurality of process nodes of the software process. The other (if any) executors of the executors 120 may execute tasks associated with other (if any) software processes.

The datastores 125 may be zero, one, or a plurality of datastores, such as structured or unstructured databases or other data storage system (e.g., time series database, a data lake, etc.). The datastores 125 (e.g., “a first datastore”) may be a storage layer for the software process execution environment 103. The datastores 125 be configured to store values of variables associated with software processes. The datastores 125 may be elastic and stateful. In some cases, the datastores 125 may be multi-tenant cloud storage systems (e.g., relational, in-memory, NoSQL, etc.). In some cases, the datastores 125 may be a set of database tables.

The datastores 125 may be exposed to executors 120 through a key-value application programming interface (API) to abstract the storage implementation in a storage layer. In some cases, the datastores 125 may be configured to store design and runtime information for both user (or organization) and system data. For instance, the datastores 125 may store software subroutines (of the object-based model from the software process database 135), process variables (variables accessible to any node in a software process), node variables (variables accessible to a particular node in a software process), internal state data associated with the particular attributes of a running process, error and debugging information, and/or statistical information or aggregate data about running or completed processes. Process executors may retrieve any of the following types of data, or any other data associated with one or more processes, by providing the appropriate key to the API to retrieve the data (i.e., value) from the datastore.

In some cases, the datastores 125 may, based on storage load (e.g., storage load, software process load, etc.) and other factors, add or remove datastores from the software process execution environment 103. Thus, the datastores 125 may include zero, one, or a plurality of datastores, as the load on the software process execution environment 103 increases or decreases. As depicted in FIG. 1, the datastores 125 may include a first datastore 125A through a Nth datastore 125N, where N is determined based on the load. As the load increases, new datastores may be added to distribute input/output process time and/or distribute storage size across all datastores of the datastores 125. In some cases, new datastores may receive migrated data from existing datastores. As the load decreases, existing datastores may migrate data to remaining datastores and end decommissioned datastores. In some cases, migrated data may be moved between datastores on a same storage device, or between datastores on different storage devices.

The task manager 115 may assign process nodes or tasks of process nodes to specific executor(s) of the plurality of executors. The means by which the assignment is conducted is by examining the information contained in a work request. A work request is a message sent from either the frontend 130 or one of the executors 120 to the task manager 115 that contains all information required by one of the executors 120 to carry out at least one task associated with at least one process node. In some cases, the task manager 115 may assign the first process node to a first executor of the plurality of executors, such that tasks associated with the first process node will be executed by the first executor, and assign the second process node to a second executor of the plurality of executors, such that tasks associated with the second process node will be executed by the second executor. In this manner, the software process execution environment 103 may execute the software process that was initiated by the frontend 130. When executing the initiated software process, the software process execution environment 103 may: execute, using the first executor, a first set of tasks associated with the first process node. In this case, the executing of the first set of tasks may cause at least a first value of the variables associated with the software process to be modified in the first datastore. Moreover, when executing the initiated software process, the software process execution environment 103 may: execute, using the second executor, a second set of tasks associated with the second process node. In this case, the executing of the second set of tasks may cause at least the first value of the variables associated with the software process to be again modified in the first datastore. In some cases, the task manager 115 may assign process nodes or tasks thereof in various methods, such as based on storage load or executor load, and the like.

In some cases, the task manager 115 may include a set of partitioned message queues (e.g., Kafka® topics). In these cases, a work request may be enqueued onto a partition of a message queue. That work request will eventually be consumed by an executor, resulting in the evaluation of some amount of software code (which could correspond to less code than is required to evaluate a single process node or correspond to the code for multiple process nodes). The executors consume work requests to advance individual software processes. A set of executors may cooperate to consume work requests from a specific topic. The number of partitions in a topic may determine a level of parallelism in the software process execution environment 103. At any given time, one partition may be consumed by exactly one executor, while multiple partitions may be consumed by a single executor. When work requests can be parallelized, the task manager 115 may enqueue (i.e., assign) work requests to different partitions (whether in random fashion or by algorithmically assigning specific work requests to specific partitions). Work requests are consumed sequentially from a single partitions. The order in which they are consumed corresponds to the order in which they are enqueued on the partition. The elastic executors 120A-N may enqueue related (i.e., using the same variables or having one be dependent in some way on the other) or unrelated work (i.e., not using the same variables and not being dependent in some way on the other) requests on a single partition. Because work requests are consumed sequentially, the execution of work requests enqueued later on a single partition will be delayed relative to the execution of work requests earlier in the queue. In these cases, software process metrics and/or executor metrics may re-balance work requests, either those already assigned or incoming work requests.

In some cases, the task manager 115 may, in response to an instruction to execute the software process (e.g., from the frontend 130), generate a plurality of tasks based on the plurality of process nodes. To assign a first set of tasks to the first executor 120A and a second set of tasks to the second executor (e.g., the Nth executor 120N), the task manager 115 may be configured to, based on load-balancing rules: assign the first set of tasks to a first sub-group of a first group and assign the second set of tasks to a second sub-group of the first group. The first executor 120A may be assigned to pull pending tasks from the first sub-group, and the second executor (e.g., the Nth executor 120N) may be assigned to pull pending tasks from the second sub-group. In some cases, the load-balancing rules may be configured to assign the plurality of tasks to sub-groups based on (1) dependencies between the process nodes, (2) number of already assigned tasks for each sub-group, (3) compute resources being utilized by the executors, (4) throughput/latency metrics of the executors, and (5) throughput/latency metrics of the software process.

To generate the plurality of tasks based on the plurality of process nodes, the task manager 115 may be configured to: generate at least one task for each process node of the plurality of process nodes. In the case that a process node is indicated to be a parallel process node or a multi-task process node, the task manager 115 may be configured to: generate at least two tasks for the process node. In some cases, the two tasks may be processed on different threads of the same executor. In some cases, the two tasks may be processed on different executors.

### Object-Based Model

FIG. 2 depicts a diagram schematically showing an object-based model 200 comprising a plurality of process nodes 202-220. The features of the object-based model 200 of FIG. 2 may apply to FIGS. 1, 3, 4A-4B, 5A-5G, and 6.

The object-based model 200 may be a graphical model stored in the software process database 135. The nodes of the object-based model 200 may correspond to software subroutines of the software process.

The plurality of process nodes 202-220 may include, at least, a start node 202, at least one end node 214/220, and optionally may include one or more intermediate nodes 204-212 and 216-218.

The start node 202 may initiate the software process. For instance, the start node 202 may be associated with the triggering conditions to start the software process. In response to a trigger condition initiating the software process, the start node 202 may cause the assigned executors of other nodes, such as at least one of the one or more intermediate nodes 204-212 and 216-218, to retrieve and store (e.g., in the first datastore 125A) associated code and/or connections (e.g., pointers to local caches or API key values for software process variables) (collectively, “preparation actions”). In some cases, additionally or alternatively, the start node 202 may be a timing mechanism to determine, e.g., metrics for the executor and/or the software process. In the case that the preparation actions are handled by the software process execution environment 103, the start node 202 may solely perform timing mechanism.

The at least one end node 214/220 may end the software process. For instance, an end node 214 or the end node 220 may indicate an end of the timing mechanism of the software process. The end node 220 may also indicate to the executor 120A-N that the software process is ended. In some cases, the software process may include end nodes that indicate an end at different points in time (e.g., a branches that are not exclusive) and each branch may end at different points in time. In some cases, the software process may include end nodes that indicate an end of the entire software process, even if other branches of the process were still being executed.

The one or more intermediate nodes 204-212 and 216-218 may perform various functions. For instance, tasks of the intermediate nodes' executors may be to perform one or combinations of: (a) retrieving a first set of values for the variables of the first software process and/or retrieve data from a different system (collectively, input data); (b) performing a function to (1) transform the input data, (2) determine a logical result of a logical expression on the input data, and/or (3) infer one or more inferences based on the input data (collectively, output data); and (b) storing the output data as a new value of a specific variable, store the output data as a value of a newly instantiated variable of the first software process, and/or create, update or delete a record.

For instance, to retrieve the first set of values, the task may determine whether to access a local cache or the datastores 125, and retrieve data therefrom, or it may determine the value of an input to an expression by evaluating an expression specified by the designer in an expression language. In some cases, the task may determine to access other systems (e.g., third parties or associated systems of the software process execution environment 103). For instance, node 204 may retrieve data associated with an event that triggered the software process depicted in FIG. 2.

In some cases, a node may transform data in the software process. For instance, node 206 may transform input data into a defined format.

In some cases, a node may determine a logical result based on variables of the software process. For instance, node 208 may determine which branch (or multiple branches) to take based on values of the variables of the software process. A logical expression may be arbitrarily complex based on input values and logical operators.

In some cases, a node may determine a calculation (e.g., of a deterministic process) or an inference (e.g., of a machine learning process) based on variables or sets of variables retrieved in earlier steps. For instance, node 216 may determine a calculation, while node 210 determines an inference based on the same or different variables of the software process.

In some cases, a node may store output data as a value of a variable (existing or new) or a record. For instance, nodes 212 and 218 may create or update records with data output by previous nodes. In some cases, intermediate values (e.g., those that do not populate a record during the software process) may be cleared before another software process executes.

In some cases, such as node 210, the task manager 115 may determine several tasks that correspond to the node 210. The several tasks may be performed in sequence (on a same executor) or on separate executors (or threads thereof) in parallel depending on configurations supplied by the designer of the node. For instance, node 210 may perform a loop functionality (e.g., a loop instance) or multiple node instance (MNI) functionality. MNI functionality may repeat the same set of actions multiple times (e.g., with different data, updated data, and the like).

### Backend

FIG. 3 depicts a block diagram 300 schematically showing a backend 140 generating objects in a software process execution environment 103. The features of the block diagram 300 of FIG. 3 may apply to FIGS. 1, 2, 4A-4B, 5A-5G, and 6. In particular, the backend 140 may include a template module 302, an update module 304, and an object generator module 308, and one or more datastores. In some cases, the backend 140 may include a user environment 306; while in other cases, the backend 140 may interact with the user environment 306 hosted on the frontend 130 or the user device 105.

The one or more datastores may include a register datastore 310, an object template datastore 312, a conflict datastore 314, and a generated object datastore 316. The one or more datastores may be structured or unstructured databases or other data storage systems (e.g., time series database, a data lake, etc.). While the register datastore 310, the object template datastore 312, the conflict datastore 314, and the generated object datastore 316 are depicted in FIG. 3 as separate datastores, the register datastore 310, the object template datastore 312, the conflict datastore 314, and the generated object datastore 316 may be combined or separated in various combinations to store the referenced data.

The backend 140 may host a software process development environment to add, update, or delete software processes based on the user inputs regarding software processes. For instance, the software process development environment may provide graphical user interfaces (see, e.g., FIGS. 5A-5G) for users to interact with the software process development environment to select, modify, and generate user-defined software processes. In some cases, the backend 140 may receive a request to initiate an object templating subroutine to generate a user-defined software process. In some cases, the object templating subroutine may automatically populate existing or generate new templated objects with user-defined data (e.g., data provided by the user at design time) or user-associated data (e.g., pre-existing system-generated or user-created data associated with the user and hosted on the environment 103). In response to the request to initiate the object templating subroutine, the backend 140 may obtain a seed file. A seed file may contain seed data relating to an object to be generated. Generally, the seed data may be parameters or values that populate pre-defined or user-defined fields in a text file with a structured data format (e.g., XML or JSON file). In some cases, the backend 140 may transmit the seed file to a user environment. The user environment may be configured to: perform validation and/or update actions to the seed data; and after validating and/or updating the seed data, transmit the validated and/or updated seed data with a request to initiate an object generation subroutine. In some cases, the validation and update actions may automatically check for certain conditions, as discussed herein, and (in some cases allow) the user to modify or change portions of the seed file. The backend 140 may receive the validated and/or updated seed data. In some cases, the backend 140 may receive a request to initiate the object generation subroutine; while in other cases, the backend 140 may automatically determine to initiate the object generation subroutine (e.g., if no user feedback or interaction is a part of a generation process). For instance, the backend 140 may initiate the object generation subroutine based on an instantiation condition. The instantiation condition may result from a user making a selection indicating approval to generate the objects or may result from a trigger condition that occurs without explicit user approval to generate objects (e.g., no conflicts and no further user input required). The backend 140 may, in response to receiving the validated and/or updated seed data and the request to initiate the object generation subroutine, generate objects by performing one or both of: (i) generating one or more new objects; and (ii) modifying one or more existing objects.

In some cases, the generated object is a logical unit in a low-code or no-code software development platform. A logical unit may be a software executable version of a software process that includes one or a plurality of software units to perform defined functions (e.g., data retrieval, data manipulation, or data storage). For instance, the logical unit may be an object-based model 200 that corresponds to software subroutines of a software process. In some cases, the generated object is configured to be displayed in a graphical model (see FIG. 2) displaying a plurality of software objects in a software architecture. In some cases, generating the object outputs a portable file configured to be deployed in a plurality of operating environments. For instance, the portable file may be an executable file (or components thereof) to deploy a runtime instance of a software process. In some cases, the backend 140 may be configured to transmit the portable file to the user environment or a user device, and the user environment/user device may be configured to use the portable file to deploy the new object and/or modified existing object.

In some cases, the generated object is at least one of: a standardized object, an account-specific object, and/or a composite object. A composite object may be a combination of at least two objects. A standardized object is one that may be made available to more than one user (based on account settings). An account-specific object may be an object available to some or all users associated with a specific account (for example, when an organization has a plurality of end users associated with the account). In some cases, the environment 103 may determine composite objects may be added as standardized objects or account-specific objects, and the like.

The template module 302 may be configured to obtain a seed file in response to a request to initiate the object templating subroutine. To obtain the seed file, the template module 302 may be configured to: select the object template from a plurality of object templates stored in the one or more data stores. For instance, the template module 302 may select the object template based on a user indication (e.g., by making a selection on a user interface) of a type of action or function to be performed by the object.

In some cases, the plurality of object templates may facilitate the generation of objects that perform a variety of software functions, such as data retrieval, data processing, data computations, data inferences, or data storage actions. In some cases, the plurality of object templates may facilitate the generation of objects that include actions associated with one or combinations of: (1) a default application, (2) a create record action, (3) an update record action, (4) a delete record action, (5) a CRUD (create, read, update, or delete) record action, (6) an event record action, (7) a view record data action, (8) data sync action, (9) a data manipulation function, and/or (10) a data structure action.

The default application may include a pre-defined subset of the various software functions. The create record action may create a new record. The update record action may update data associated with a record. The delete record action may delete an existing record. The CRUD record action may perform one or more of create, read, update, or delete. In some cases, the CRUD and related actions may be performed in bulk. The event record action may generate event records to track changes to records over time. The view record data action may retrieve data from a record and generate a graphic/data for display to users. The data sync action may check that data is synchronized between a first source and second source, and, if not, update one of the sources (e.g., based on time, sequence, and the like). The data manipulation function may perform arbitrary software functions. For instance, the data manipulation function may perform calculations, check conditions, perform inferences, and the like. The data structure action may generate, update, or delete a file, a database, a table in a database, a record in a database, a data structure, and the like.

In some cases, the template module 302 may interact with the register datastore 310 to store and track requests with generated objects/seed files. In this manner, groups of users (e.g., associated under a single organization) may share access to or track generated objects. The object template datastore 312 may store and update the plurality of object templates. The object template datastore 312 may store the object templates according to access rules, such as (1) generally available, (2) only available to certain organizations, and the like.

In some cases, the seed file may contain fields, which constitute metadata, that are to be populated with seed data by the object generation subroutine after the seed data has been validated and/or updated in the user environment. In some cases, the fields may be populated with data provided by the user and/or populated with data associated with the user stored in one or more data stores. For instance, a data source ID, a security group ID, a name field, a function field, and the like may be fields populated from user inputs or account information associated with the user/user device.

In some cases, the seed file may include at least two metadata sections. The two metadata sections may include a first metadata section and a second metadata section. The first metadata section may include identification or description data, and the second metadata section may include object metadata.

In some cases, the seed data may include groups of metadata within the object metadata. Each group of metadata may correspond to a particular object type and contain metadata used to generate or update at least one object. In some cases, each group of metadata may include a trigger subsection and an object metadata subsection. In some cases, the trigger subsection may define dependent object/field relationships. In some cases, based on the trigger subsection, the backend 140 may update a dependent object or field when a parent object (e.g., that has the trigger subsection) is updated.

In some cases, the seed file may further include a third metadata section. The third metadata section may define a user interface model to generate graphical user interfaces that are used to customize object templates. For instance, the third metadata section may define a wizard to customize the seed data. The seed file may not have this section if objects are generated directly from the seed data, which means an action does not support the customization of metadata of the seed data.

As an example, a generated seed file may include:

### 1^{st} Metadata Section:

“id”: “BULK_RECORD_TYPE_ACTIONS”,
“version”: 2,
“summaryTitle”: “ . . . ”,
“summaryObjectStatsInstructions”: “ . . . ”,
“summaryCreateObjectsInstructions”: “ . . . ”,

### 2^{nd} Metadata Section:

“Design object”: {
   “GROUP”: [
      . . .
   ],
   “RULE_FOLDER”: [
      . . .
   ],
   “INTERFACE”: [
      . . .
   ],
   “PROCESS_MODEL”: [
      . . .
   ],
   “CONTENT_FREEFORM_RULE”: [
      . . .
   ],
   “PROCESS_MODEL_FOLDER”: [
      . . .
   ]
}

Where design objects include one or more types from the following:
(i) Application. An application may store one or more (e.g., dozens) objects for supporting a particular business solution or service.
(ii) Interface. An interface may be a primary structure for holding custom business logic and its visualization through out-of-box controls or manually written expressions.
(iii) Expression Rule. An expression rule may be custom business logic written in a programming language (including declarative programming languages, such as SAIL, or functional programming languages). An expression rule may be similar to Interface, but it does not include UI components.
(iv) Process Model. A process model may define a business process/flow for executing business rules, manipulate data, integrate with other systems, and the like.
(v) Group. A group may set privileges and restrictions granted to users who belong to that group.
(vi) Report. A report may be an object to display graphics, such as charts and grids based on an expression.
(vii) Site. A site may be a web-based endpoint that provides access to an application.
(viii) Web API. A web API may be an endpoint to expose system data and services to outside systems.
(ix) Folder. A folder may be a logical and/or physical container used to store similar objects. Examples of containers include:
   a. Knowledge center. A knowledge center may be a parent folder for all folders within the same application.
   b. Process Model Folder. A process model folder may be a folder that stores process models.
   c. Rule folder. A rule folder may be a folder that stores definitions of interfaces and expression rules.
   d. Document folder. A document folder may be a folder that stores documents or any artifacts uploaded by an organization. In some cases, the documents or artifacts may be accessible in the Application.
(x) Data Store. A data store may be configured to connect the system to one or more external databases in order to store and retrieve application data.
(xi) Custom Data Type. A custom data type may be a designer-defined data structure that represents a logical grouping of related data, such as the set of all fields related to a particular employee or contract.
(xii) Record Type. A record type may be a presentation of particular business data (such as in-memory record or database table). The record type may include actions for modifying and evolving a business record. Each action may be backed by other objects such as: Interface, Process Model, Expression Rule, and Groups.
(xiii) Decision. A decision is a grouping of business rules that determines output values based on a set of inputs. Unlike expression rules, which primarily calculate or manipulate data, decisions may be used to encapsulate complex, business-specific logic. Decisions may be configured in the decision designer, which enables fast, intuitive implementation of business logic without using expressions by way of decision tables.
(xiv) Constant. A constant is a literal value that can be called from any expression, so it can be reused across multiple objects throughout the system.
(xv) Connected System. Connected Systems store authentication and connection information. This allows a user to easily connect to external integrations and data sources. It also allows a user to deploy connection information across environments and use different connection information for each environment.
(xvi) Integration. An Integration provides the channel to external HTTP, OpenAPI, and SQL endpoint which can be used to define a Connected System.

### 3^{rd} Metadata Section:

“uiModel”: [
   {
      “name”: “ . . . ”,
      “subsectionLabel”: “ . . . ”,
      “recipeObjectIds”: [
         “$ {interfaceRecipeId_createUpdate}”,
         “$ {processModelRecipeId_createUpdate},
         “$ {queryRuleRecipeId_update}”
      ]
   },
   {
      “name”: “ . . . ”,
      “description”: “ . . . ”,
      “link”: “ . . . ”,
      “icon”: “ . . . ”,
      “recipeObjectIds”: [
         “$ {adminGroupRecipeId}”,
         “$ {userGroupRecipeId}”,
         “$ {ruleFolderRecipeId}”,
         “$ {processModelFolderRecipeId}”
      ]
   }
]

In some cases, a trigger subsection may be used to inform dependent objects/fields about changed metadata properties. For example, almost all objects may be secured using groups; in the case when a different group is selected, objects referencing a replaced group must be updated. In some cases, each trigger may include two parts: source section and target section. A source section may represent a customized/changed object, such as:
a. fieldName—a field or a metadata property which was changed;
b. statuses—the object state for firing a trigger;
c. isArray—the flag indicates if a field/property is a composite data structure (array, collection, map);
d. actions—the list of actions associating with the change;
e. recipeObjectId—the identification of metadata for creating/updating a single particular design object; and
f. objectType of source object which corresponds to an object type.

The target section may represent dependent objects/fields directly/indirectly affected by a change in a source object. Each entry may include the following properties:
a. fieldName—a field, field path, or a metadata property in a target object;
b. statuses—the target object state accepting a trigger;
c. isArray—the flag indicates if a target field/property is a composite data structure (array, collection, mao);
d. actions—actions to invoke on a target object after receiving a trigger;
e. recipeObjectId—the identification of target metadata for creating/updating a single particular object; and
f. objectType of target metadata which corresponds to an object type.

An example trigger subsection may be as follows:
“triggers”: [
   {
      “source”: {
         “fieldName”: “uuid”,
         “statuses”: [
         “NEW”,
         “EXISTING”,
         “EXISTING_UPDATED”
         ],
         “isArray”: “false”,
         “actions”: [
         “SELECT_OBJECT”
         ],
         “recipeObjectId”: “CONTENT_FREEFORM_RULE-0”,
         “objectType”: “CONTENT_FREEFORM_RULE”
      },
      “targets”: [
         {
         “fieldName”:“displayNameUuid”,
         “statuses”: [
         “NEW”
         ],
         “isArray”: “false”,
         “actions”: [
         “UPDATE_FIELD”
         ],
         “recipeObjectId”: “PROCESS_MODEL-0”,
         “objectType”: “PROCESS_MODEL”
         }
      ]
   }
],
The object metadata subsection may include fields required to generate the portable presentation of an object. The object metadata subsection may have a header section and a specific metadata section.

The header section may have the following properties:
1. version—the version supporting this syntax/structure of the seed file;
2. recipeObjectId—the identification of metadata for creating/updating a single particular object;
3. objectType of source object which corresponds to an object type;
4. replaceable—the flag indicates if an object can be replaced by an existing one;
5. selectedObjectIndex—the number indicated the current selected object metadata in the case when a templating object can be replaced with a few existing ones;
6. isVisible—the flag indicates if a templating object is exposed in UI so a user can review or customize it;
7. isImportable—the flag indicates if an object metadata should be converted to XML for creating or updating a desired object;
8. templateForUpdate—the path to a Template Engine artifact for transforming the portable XML representing an existing object in order to update that object;
9. templateForReuse—the path to a Template Engine artifact file to generate a metadata to represent a reused object; and
10. templateForCreate—the path to a Template Engine artifact which generates the portable XML to create an object.

The specific metadata section may include tracking/object uniqueness data in metadata.

Thus, in this manner, seed data of different template objects (alternatively, referred to as template recipes) may be populated using user-provided or system-provided data in a process that ensures: (1) design consistency, (2) increased security, and (3) functional inter-operability with the environment 103. Moreover, the process ensures that developers do not have to implement design practices, structure, data population, security, or inter-operability with the environment 103.

The update module 304 may perform the validation and/or update actions on a generated seed data of a seed file. In some cases, the validation and/or update actions may determine whether to generate a new object and/or whether to modify or reference/use an existing object. In some cases, the validating and/or updating the seed data/seed file in the user environment may be performed, at least in part, based on design rules established by the environment 103 and configured to enforce best design practices in the user environment. The design rules may be programmatic relationship rules about minimum data fields for objects, metadata, and the like; types of data in fields; data formats for fields; types of actions that can be sequenced together, and the like.

In some cases, the validating and/or updating the seed data/seed file in the user environment may be performed, at least in part, based on user inputs received by the user environment via a graphical user interface. In some cases, the user inputs may be user intentions (e.g., a type of action or file to generate as part of a software process). In some cases, the user inputs may indicate specific actions to perform or records/file/databases to update.
To perform the validation and/or update actions, the update module 304 may deconflict objects, functions, fields, or names of the seed data with existing data associated with the environment 103. In some cases, the deconflict process may check environment-wide data (e.g., root variables and the like) or check account specific data (e.g., deployed objects, security groups, variables, record, databases, and the like) against the seed data; and if a conflict is found, recommend an alternative name or recommend a replacement to use for the existing object found whose name conflicts with the seed data. In some cases, the deconflict process may perform one or combinations of: (1) a name deconflict process, (2) a reusable object process; (3) an authorization process; and/or (4) a customization process. Other deconflict processes may include URL deconflicts, uniqueness of containment relationship, and/or valid values/properties (e.g., for graphics or charts, such as a PIE chart may only have one measure; table names must adhere to naming conventions, such as maximum length). The user environment 306 may store the seed data of the seed file. The user environment 306 may update the seed data in accordance with instructions from the update module 304/user device 105.

In some cases, the seed file may include one or more proposed objects, and the request to initiate the object templating subroutine may be associated with a user account (e.g., by user ID or user credentials of the request). The user account may be associated with existing objects (e.g., of an organization account).

The update module 304 may retrieve data from, add data to, and remove data from the conflict datastore 314. The conflict datastore 314 may store (1) a set of names of the existing objects, (2) a set of name-function pairs for the existing objects, (3) a security policy associated with the user account, and the like.

To perform the name deconflict process, the update module 304 may: check each name of the one or more proposed objects against the set of names of the existing objects. For instance, the update module 304 may determine that text strings that match between the one or more proposed objects against the set of names of the existing objects and return matching strings (or sub strings of a threshold similarity). If a conflict is determined for a first name of a first object, the update module 304 may generate a new name for the first object. For instance, the update module 304 may automatically replace with the matching name or recommend the matching name.

To perform the reusable object process, the update module 304 may: check each name and function of the one or more proposed objects against the set of name-function pairs for the existing objects. For instance, the update module 304 may determine if text strings of names match and also if the type of objects matches. If a conflict is determined for a first name-function pair of a first object with a matching object, the update module 304 may recommend the first object to be replaced by the matching object. Similarly, the update module 304 may determine whether groups or folders may be re-used and, if so, enforce or recommend re-usable groups or folders.

To perform the authorization process, the update module 304 may: check security groups of the one or more proposed objects against the security policy associated with the user account. For instance, the update module 304 may determine if a user requesting the object has authorization to access certain data or perform certain actions (e.g., delete a record), move data between different environments, and the like. If a conflict with the security policy is determined for a first object, the update module 304 may recommend a set of security groups for the first object. For instance, the update module 304 may recommend authorized groups (e.g., based on the user authorization) or storage locations, and the like. Similarly, before a user can issue a particular object generation request, the update module 304 may check if the user has privileges for types of objects which will be generated or updated by such request. For instance, a user must belong to a process model creator group in order to be allowed to generate a process model (e.g., a record action).

To perform the customization process, the update module 304 may: generate modified graphical user interfaces based on the seed data; transmit the graphical user interfaces to the user device; receive user requests via the modified graphical user interfaces; and update the seed data based on the user requests. See FIGS. 5A-5G. In some cases, the update module 304 may re-check the updated seed data to confirm other deconflict processes are still satisfied after a user input requests a change.

To generate the object, the object generator module 308 uses a set of templates to produce portable presentations of new or existing objects, which may be an object-based model 200 (e.g., to be executed in the environment 103) or a software package (or subset thereof) to execute in a user environment. Generated portable objects can be deployed in any user environment 306, which is compatible with the definition version of those objects. A seed data and a recipe version associated with that seed data determine which particular generation template produces portable objects. Thus, the recipe versioning and the portable nature of objects allow the object template framework to simultaneously support different user environments 103 and “Continuous Integration and Deployment” and NoCode/LowCode development practices those environments follow.

Generated portable objects may be packaged to a deployable file. The deployable file may consist of the set of new or existing objects, and data supporting those objects. For instance, the object generator module 308 may perform one or both of: (i) generating a new object; and (ii) modifying an existing object. For example, additional data in a deployable file might be database scripts, configuration files or graphical artifacts.

In the case of generating a new object, the object generator module 308 may generate the deployable file (e.g., XML) for the generated object based on a first template and injections. To generate the deployable file, the generator module 308 may obtain the first template (e.g., a new object template such as a FTLX file) and inject data in a defined syntax (e.g., XML syntax) from the seed data (as modified or original). For instance, based on the object type to be generated, the generator module 308 may obtain a first new object template and inject specific data bits into fields to generate the deployable file. As an example, the object generator module 308 may export an existing object into a portable data structure (such as XML); use specific pre-defined transformation to either add, update, or remove snippets of code in a portable data structure (for example using XSLT); and import an updated portable data structure into a design object.

Objects further may be portable, meaning that the recipes may generate sets of objects that can be ported to different software process execution environments. Due to the portable nature of objects, different recipes that produce those object types can coexist, and the system may dynamically select the correct recipe to execute based on external factors, such as the version of the software process execution environment.

In the case of modifying an existing object, the object generator module 308 may generate the deployable file (e.g., XML) for the generated object based on a second template and injections. To generate the deployable file, the generator module 308 may obtain the second template (e.g., an existing object template such as an XSL file) and inject data in a defined syntax (e.g., XML syntax) from the seed data (as modified or original). For instance, based on the object type to be generated, the generator module 308 may obtain an XSL file for transforming XML of an existing object, and inject specific data bits into fields with preexisting values to generate the deployable file. In this manner, new XML data is injected in place of existing XML data in the existing XSL file to create a new XSL object. For instance, based on the object type to be generated, the generator module 308 may obtain an XSL file for updating XML of an existing object with XML code snippets corresponding to the logical modification of that existing object.

In the case of multiple objects (e.g., an application with multiple templates being used), the object generator module 308 may modify existing objects and/or generate new objects on an individual object-basis. Thus, the object generator module 308 may leverage existing objects to generate complex software processes without generating all new individual objects.

The generated object datastore 316 may store and track generated objects, e.g., by account, user, group, application, and the like. For instance, the generated object datastore 316 may store generated objects before the generated objects are deployed.

In some cases, a system for partially-automated software development may include: a client device, a frontend system, and a backend system. The client device may be associated with a user account and configured to receive user intentions via graphical user interfaces. The frontend system may be configured to manage interactions with one or more client devices. The one or more client devices may be configured to receive user intentions via one or more graphical user interfaces. The backend system may be configured to manage a plurality of template recipes and generate software objects based on one or more of the plurality of template recipes. The system may be configured to: provide, via the frontend system, the graphical user interfaces to the client device; receive, via the frontend system, the user intentions from the client device; generate, via the backend system, a seed file based on the user intentions, wherein the seed file contains seed data relating to an object to be generated; using the frontend system, perform validation and/or update actions to the seed data based on (1) design rules and (2) user requests, via the graphical user interfaces; in response to an being satisfied, generate, via the backend system and based on the validated and/or updated seed data, a second file configured to instantiate a run-time version of the object; and deploy the run-time version of the object.

### Dataflow Diagrams

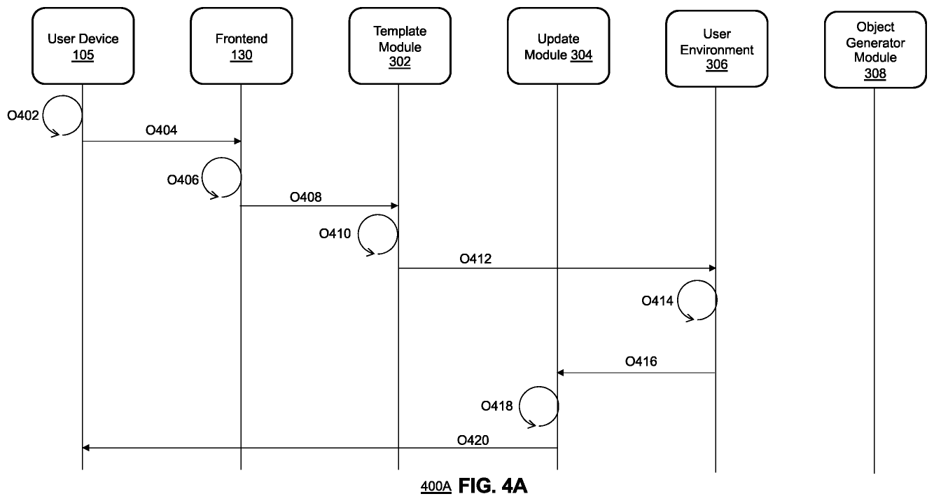

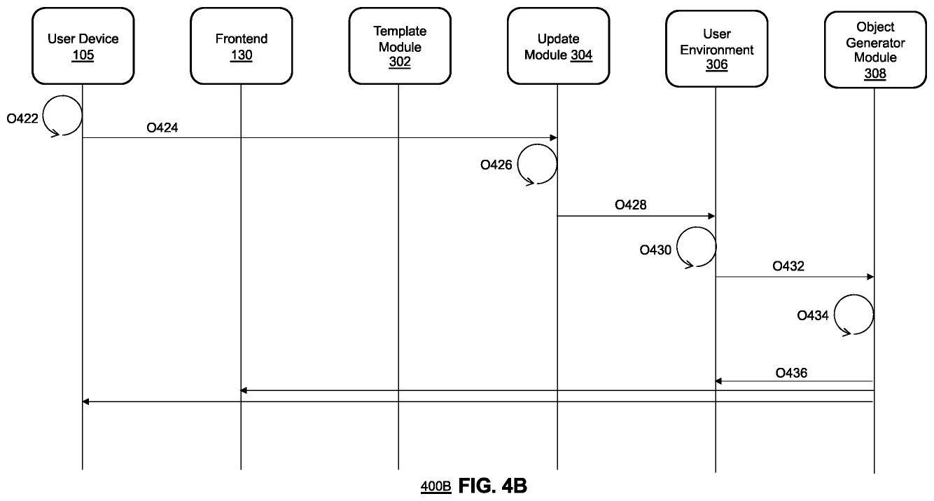

FIGS. 4A and 4B depict dataflow diagrams 400A and 400B for generating objects in a low-code or no-code software process execution environment. The features of the dataflow diagrams 400A and 400B of FIGS. 4A and 4B may apply to FIGS. 1, 2, 3, 5A-5G, and 6. In particular, various components of the environment 100 may interact to generate objects, as discussed herein. The various components may perform operations O402 through O436 to generate objects, as discussed herein.

In operation O402, the user device 105 may receive user inputs via graphical user interface(s) to make selections/data inputs and to cause a request to be transmitted to initiate an object templating subroutine, as discussed herein. In operation O404, the user device 105 may transmit a request to initiate the object templating subroutine. The frontend 130 may receive the request to initiate the object templating subroutine.

In operation O406, the frontend 130 may process the request (to confirm the format, user authorization, and the like) and determine to route the request to the template module 302. In operation O408, the frontend 130 may initiate the object templating subroutine by relaying the request to the template module 302. The template module 302 may receive the request.

In operation O410, the template module 302 may obtain a seed file by selecting a template (e.g., based on user indications in the user request) and populating data in the template based on user indications in the user request, the user account, or an account associated with the user (e.g., an organization account), as discussed herein. In operation O412, the template module 302 may transmit the seed file to the user environment 306. The user environment 306 may receive the seed file.

In operation O414, the user environment 306 may store and update the seed file based on instructions from the user device 105 and the update module 304, as discussed herein.

In operation O416, the user environment 306 may transmit a request to validate/update the seed data to the update module 304. The update module 304 may receive the request.

In operation O418, the update module 304 may perform validate/update actions on the seed data. For instance, the update module 304 may perform a data deconflict processes, automatically change certain data (e.g., based on triggering conditions), and generate recommendations, as discussed herein. In some cases, like in operation O420, the update module 304 may transmit graphical user interfaces to the user device 105. The graphical user interfaces may be displayed to the user to: (1) inform the user of progress, (2) recommendations, and (3) the option to proceed with object generation.

In operation O422, the user device 105 may receive user inputs indicating user selections, approval of recommendations in the graphical user interfaces, and/or user indication to proceed with object generation. In operation O424, the user device 105 may transit user inputs to the update module 302. The update module 302 may receive the user inputs.

In operation O426, the update module 304 may re-perform validate/update actions based on the user input. In the case certain user inputs are not accepted by the update module 304, the update module 304 may transmit denials or recommended actions to resolve issues. In the case that the user inputs are acceptable, the update module 304 may determine to proceed with updating the seed data. In operation O428, the update module 304 may transmit updates to seed data in the seed file to the user environment 306. The user environment 306 may receive the updates to the seed data.

In operation O430, the user environment 306 may update seed data and determine to initiate the object generation subroutine. In some cases, the user environment 306 and/or the update module 304 may propagate changes based on triggering conditions between objects. In some cases, the user environment 306 may determine an instantiation condition is satisfied (e.g., a user input indicating to proceed, or the seed data is acceptable and no user input is needed for this object).

In operation O432, the user environment 306 may transmit a request to initiate the object generation subroutine to the object generator module 308. The object generator module 308 may receive the request to initiate the object generation subroutine.

In operation O434, the object generator module 308 may generate an object based on the seed data in the user environment 306, as discussed herein. In operation O436, the object generator module 308 may store and/or deploy the object. For instance, the object generator module 308 may transmit the object to the frontend 130, so that the object may be hosted and executed (as the object is invoked), or the object generator module 308 may transmit the object to the user device 105 (or a device association with the user device 105), so that the object can be hosted and executed a user-managed system.

### Graphical User Interfaces

FIGS. 5A-5G depict, respectively, graphical user interfaces 500A, 500B, 500C, 500D, 500E, 500F, and 500G in a process to generate objects in a low-code or no-code software process execution environment. The features of the graphical user interfaces 500A, 500B, 500C, 500D, 500E, 500F, and 500G of FIGS. 5A-5G may apply to FIGS. 1, 2, 3, 4A-4B, and 6.

In graphical user interface 500A, the system may generate and cause a user device 105 to display the graphical user interface 500A. In some cases, the graphical user interface 500A is for an application process for creating a new application that includes one or more default objects, which can be modified based on user input data or data associated with the user. The graphical user interface 500A may start a process for creating a new application with default objects. Such default objects may be of a type that are reused by other objects within the same application. For instance, they may be groups, directories, rules, or other object types that are referenced by one or more other objects within an application. The graphical user interface 500A may include various data fields, e.g., name field 502, various selection elements, e.g., selection box 504, and various elements to signify to object generator module 308 to create the default objects, e.g., create button 506. The data fields, e.g., field 502, may be user selectable to enter relevant data (e.g., the application name, a description of the application, and the like). The selection elements, e.g., selection box 504, may be user selectable to toggle or select characteristics of the object to be generated or may be elements found in a dropdown box or list box which allow selection of one or more items within the box. For instance, in this case, a menu element may toggle the signal to object generator module 308 to create or not create default group objects and folders objects, e.g., to organize and secure objects being generated. The elements to signal creation of the default objects, e.g., create button 506, may in addition to signaling the creation of the default objects, also allow a user to move to a next user interface.

In graphical user interface 500B, the system may generate and cause the user device 105 to display the graphical user interface 500B, e.g., in response to a user input selecting the create element, e.g., create button 506, or as a pop-up before proceeding. The graphical user interface 500B may display first filter options 508 (e.g., by type), panels 510 to display different options (e.g., objects, plug-ins, account objects, etc.), and search options 510 (text search) and 512 (type search). Based on user inputs to search options, filter options, and panels, different sets of results 514 may be displayed. The results 514 may be user selectable to add (or remove) specific objects to the object to be generated.

In graphical user interface 500C, the system may generate and cause the user device 105 to display the graphical user interface 500C (a) in response to a user indicating that they want to generate record types based on a data/process flow, or (b) in response to a user input selecting the create element, e.g., create button 506 of the graphical user interface 500A, or after interacting with the graphical user interface 500B. The graphical user interface 500C may display action types 516, a customize element 519, and a generate element 518. The action types 516 may be user selectable to create one or more action types for the generated object. The generate element 518 may be user selectable to cause the system to proceed with the process of generating the action types selected by the user. The customize element 519 may be user selectable to cause the system to proceed to graphical user interface 500D.

In graphical user interface 500D, the system may cause the user device 105 to display the graphical user interface 500D in response to the user selecting the customize element 519. The graphical user interface 500D may display the first functional block 520 (corresponding to selected action types on the graphical user interface 500C). The first functional block 520 may have fields for data entry (e.g., for names, description, and the like), and an icon selection to correspond to the action. The graphical user interface 500D may also display a review request element 522 that is user selectable to proceed with seed file generation and/or validation/updated actions.

In graphical user interface 500E, the system may generate and cause the user device 105 to display the graphical user interface 500E in response to the user selecting the review request element 522. The graphical user interface 500E may display a second functional block 524 (corresponding to selected action types on the graphical user interface 500C). The second functional block 524 may have fields for displaying data (e.g., for names, description, and the like), and action options menus 526. The action options menus 526 may display options to update the names, functions, and the like (see FIG. 5F) of actions. The graphical user interface 500E may also display security and organization options 528 including modification options 530. In some cases, the modification options 530 may launch a graphical user interfaces to make changes to security or access rules for groups. In some cases, the security and organization options 528 and modification options 530 may only be displayed to users have access credentials to make the changes to security or access rules for groups. The graphical user interface 500E may also display a generate element 532 that is user selectable to proceed with object generation.

In graphical user interface 500F, the system may generate and cause the user device 105 to display different types of action options menus 526 or modification options 530. In some cases, action options menus 526 or modification options 530 may include a rename option 534. In some cases, action options menus 526 or modification options 530 may include a replace option 536 (e.g., to replace the object specified with a generated object or existing object). In some cases, action options menus 526 or modification options 530 may include a rename or replace option 538 (e.g., to rename an object or to replace with an existing object).

In graphical user interface 500G, the system may generate and cause the user device 105 to display the graphical user interface 500G in response to the user selecting the generate element 532 and, e.g., the generation is successful. The graphical user interface 500G may display generation results 528 in a record type editor.

### Computer System

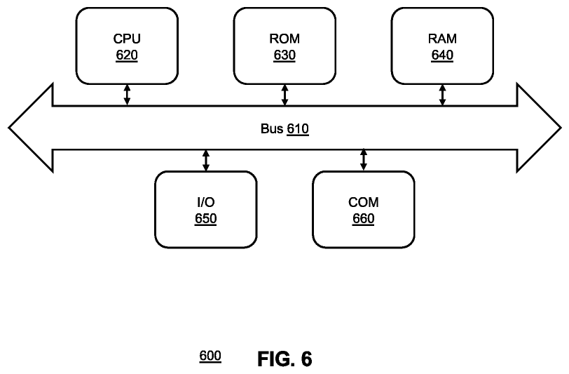

FIG. 6 depicts an example system that may execute techniques presented herein. FIG. 6 is a simplified functional block diagram of a computer that may be configured to execute techniques described herein, according to exemplary cases of the present disclosure. Specifically, the computer (or “platform” as it may not be a single physical computer infrastructure) may include a data communication interface 660 for packet data communication. The platform may also include a central processing unit (“CPU”) 620, in the form of one or more processors, for executing program instructions. The platform may include an internal communication bus 610, and the platform may also include a program storage and/or a data storage for various data files to be processed and/or communicated by the platform such as ROM 630 and RAM 640, although the system 600 may receive programming and data via network communications. The system 600 also may include input and output ports 650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### Examples

Exemplary embodiments of the systems and methods disclosed herein are described in the numbered paragraphs below.

A1. A system for partially-automated software development, the system comprising:
a processing unit comprising one or more processors;
one or more data stores comprising machine-readable instructions, wherein the system is configured to:
   receive a request to initiate an object templating subroutine;
   in response to the request to initiate the object templating subroutine, obtain a seed file, the seed file containing seed data relating to an object to be generated;
   perform validation and/or update actions to the seed data; and
   generate the object by performing an action.
A2. The system of A1, wherein the generated object is a logical unit in a low-code or no-code software development platform.
A3. The system of A2, wherein the generated object is configured to be displayed in a graphical model displaying a plurality of software objects in a software architecture.
A4. The system of any of A1-A3, wherein, to obtain the seed file, the system is configured to: select the seed file from a plurality of object templates stored in the one or more data stores.
A5. The system of A4, wherein the plurality of object templates include one or combinations of: (1) a default application, (2) a create record action, (3) an update record action, (4) a delete record action, (5) a CRUD record action, (6) an event record action, (7) a view record data action, (8) data sync action, (9) a data manipulation function, and/or (10) a data structure action.
A6. The system of any of A1-A5, wherein the seed file contains metadata that is configured to be used by the object generation subroutine after the seed data has been validated and/or updated.
A7. The system of any of A1-A6, wherein the seed file contains metadata that is populated with data provided by the user and/or populated with data associated with the user stored in one or more data stores.
A8. The system of any of A1-A7, wherein the validation and/or update actions comprise determining whether to generate the new object and/or whether to modify or reference/use the existing object.
A9. The system of any of A1-A8, wherein generating the object outputs a portable file configured to be deployed in a plurality of operating environments.
A10. The system of A9, wherein the system is further configured to transmit the portable file to a user environment, the user environment being configured to use the portable file to deploy the new object and/or modified existing object.
A11. The system of any of A1-A10, wherein validating and/or updating the seed file is performed, at least in part, based on design rules established by the system and configured to enforce best design practices.
A12. The system of any of A1-A11, wherein validating and/or updating the seed file is performed, at least in part, based on user inputs received via a graphical user interface.
A13. The system of any of A1-A12, wherein the object is at least one of: a standardized object, an account-specific object, and/or a composite object.
A14. The system of A13, wherein each composite object is a combination of at least two objects.
A15. The system of any of A1-A14, wherein, to perform the validation and/or update actions, the system is configured to: perform one or combinations of: (1) a name deconflict process, (2) a reusable object process; (3) an authorization process; and/or (4) a customization process.
A16. The system of A15, wherein the seed file includes one or more proposed objects, the request to initiate the object templating subroutine is associated with a user account, the user account is associated with existing objects, and the name deconflict process: checks each name of the one or more proposed objects against a set of names of the existing objects; and, if a conflict is determined for a first name of a first object, generates a new name for the first object.
A17. The system of A15, wherein the seed file includes one or more proposed objects, the request to initiate the object templating subroutine is associated with a user account, the user account is associated with existing objects, and the reusable object process: checks each name and function of the one or more proposed objects against a set of name-function pairs for the existing objects; and, if a conflict is determined for a first name-function pair of a first object with a matching object, recommends the first object to be replaced by the matching object.
A18. The system of A15, wherein the seed file includes one or more proposed objects, the request to initiate the object templating subroutine is associated with a user account, the user account is associated with existing objects, and the authorization process: checks security groups of the one or more proposed objects against a security policy associated with the user account; and, if a conflict with the security policy is determined for a first object, recommends a set of security groups for the first object.
A19. The system of A15, wherein the customization process: generates modification graphical user interfaces based on the seed data; receives user requests via the modification of graphical user interfaces; and updates the seed data based on the user requests.
A20. The system of any of A1-A19, wherein the seed file includes least two metadata sections including a first metadata section and a second metadata section, wherein the first metadata section includes identification or description data, and the second metadata section includes object metadata.
A21. The system of A20, wherein the seed data includes groups of metadata, each group corresponds to a particular object type and contains metadata to generate or update at least one object.
A22. The system of A21, wherein each group includes a trigger subsection and an object metadata subsection, wherein the trigger subsection defines dependent object/field relationships.
A23. The system of A22, wherein the system is configured to, based on the trigger subsection, update a dependent object or field when a parent object is updated.
A24. The system of A20, wherein the seed file further includes a third metadata section, and the third metadata section defines a user interface model to generate modification graphical user interfaces to customize object templates.
A25. The system of any of A1-A24, wherein the action may be one or combinations of: (i) generating a new object; (ii) modifying an existing object.; or (iii) generating a data base table.
A26. A computer-implemented method for partially-automated software development, the computer-implemented method comprising:
receiving a request to initiate an object templating subroutine;
in response to the request to initiate the object templating subroutine, obtaining a seed file, the seed file containing seed data relating to an object to be generated;
performing validation and/or update actions to the seed data; and
generating the object by performing one or both of: (i) generating a new object; and (ii) modifying an existing object.
A27. A system for partially-automated software development, the system comprising:
a client device associated with a user account and configured to receive user intentions via graphical user interfaces;
a frontend system configured to manage interactions with one or more client devices, the one or more client devices being configured to receive user intentions via one or more graphical user interfaces; and
a backend system configured to manage a plurality of template recipes and generate software objects based on one or more of the plurality of template recipes; wherein the system is configured to:
   provide, via the frontend system, the graphical user interfaces to the client device;
   receive, via the frontend system, the user intentions from the client device;
   obtain, via the backend system, a seed file based on the user intentions, wherein the seed file contains seed data relating to an object to be generated;
   using the frontend system, perform validation and/or update actions to the seed data based on (1) design rules and (2) user requests, via the graphical user interfaces;
   in response to an instantiation condition being satisfied, generate, via the backend system and based on the validated and/or updated seed data, a second file configured to instantiate a run-time version of the object; and
   deploy the run-time version of the object.
A28. A computer-implemented method for partially-automated software development, the computer-implemented method comprising:
providing, via a frontend system, graphical user interfaces to a client device;
receiving, via the frontend system, user intentions from the client device;
obtaining, via a backend system, a seed file based on the user intentions, wherein the seed file contains seed data relating to an object to be generated;
using the frontend system, performing validation and/or update actions to the seed data based on (1) design rules and (2) user requests, via the graphical user interfaces;
in response to an instantiation condition being satisfied, generating, via the backend system and based on the validated and/or updated seed data, a second file configured to instantiate a run-time version of the object; and
deploying the run-time version of the object.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for partially-automated software development, the system comprising:
a processing unit comprising one or more processors; and
one or more data stores comprising machine-readable instructions, wherein the system is configured to:
receive a request to initiate an object templating subroutine;
in response to the request to initiate the object templating subroutine, obtain a seed file, the seed file containing seed data relating to an object to be generated;
perform validation and/or update actions to the seed data; and
generate the object by performing an action.

2. The system of claim 1, wherein the generated object is a logical unit in a low-code or no-code software development platform.

3. The system of claim 2, wherein the generated object is configured to be displayed in a graphical model displaying a plurality of software objects in a software architecture.

4. The system of claim 1, wherein, to obtain the seed file, the system is configured to: select the seed file from a plurality of object templates stored in the one or more data stores.

5. The system of claim 4, wherein the plurality of object templates include one or combinations of: (1) a default application, (2) a create record action, (3) an update record action, (4) a delete record action, (5) a CRUD record action, (6) an event record action, (7) a view record data action, (8) data sync action, (9) a data manipulation function, and/or (10) a data structure action.

6. The system of claim 1, wherein the seed file contains metadata that is configured to be used by the object generation subroutine after the seed data has been validated and/or updated.

7. The system of claim 1, wherein the seed file contains metadata that is populated with data provided by the user and/or populated with data associated with the user stored in one or more data stores.

8. The system of claim 1, wherein the validation and/or update actions comprise determining whether to generate the new object and/or whether to modify or reference/use the existing object.

9. The system of claim 1, wherein generating the object outputs a portable file configured to be deployed in a plurality of operating environments.

10. The system of claim 9, wherein the system is further configured to transmit the portable file to a user environment, the user environment being configured to use the portable file to deploy the new object and/or modified existing object.

11. The system of claim 1, wherein validating and/or updating the seed file is performed, at least in part, based on design rules established by the system and configured to enforce best design practices.

12. The system of claim 1, wherein validating and/or updating the seed file is performed, at least in part, based on user inputs received via a graphical user interface.

13. The system of claim 1, wherein the object is at least one of: a standardized object, an account-specific object, and/or a composite object.

14. The system of claim 13, wherein each composite object is a combination of at least two objects.

15. The system of claim 1, wherein, to perform the validation and/or update actions, the system is configured to: perform one or combinations of: (1) a name deconflict process, (2) a reusable object process; (3) an authorization process; and/or (4) a customization process.

16. The system of claim 1, wherein the seed file includes least two metadata sections including a first metadata section and a second metadata section, wherein the first metadata section includes identification or description data, and the second metadata section includes object metadata.

17. The system of claim 16, wherein the seed data includes groups of metadata, each group corresponds to a particular object type and contains metadata to generate or update at least one object.

18. The system of claim 17, wherein each group includes a trigger subsection and an object metadata subsection, wherein the trigger subsection defines dependent object/field relationships.

19. A computer-implemented method for partially-automated software development, the computer-implemented method comprising:
receiving a request to initiate an object templating subroutine;
in response to the request to initiate the object templating subroutine, obtaining a seed file, the seed file containing seed data relating to an object to be generated;
performing validation and/or update actions to the seed data; and
generating the object by performing one or both of: (i) generating a new object; and (ii) modifying an existing object.

20. A system for partially-automated software development, the system comprising:
a client device associated with a user account and configured to receive user intentions via graphical user interfaces;
a frontend system configured to manage interactions with one or more client devices, the one or more client devices being configured to receive user intentions via one or more graphical user interfaces; and
a backend system configured to manage a plurality of template recipes and generate software objects based on one or more of the plurality of template recipes; wherein the system is configured to:
provide, via the frontend system, the graphical user interfaces to the client device;
receive, via the frontend system, the user intentions from the client device;
obtain, via the backend system, a seed file based on the user intentions, wherein the seed file contains seed data relating to an object to be generated;
using the frontend system, perform validation and/or update actions to the seed data based on (1) design rules and (2) user requests, via the graphical user interfaces;
in response to an instantiation condition being satisfied, generate, via the backend system and based on the validated and/or updated seed data, a second file configured to instantiate a run-time version of the object; and
deploy the run-time version of the object.
